(19) United States
(12) Patent Application Publication
(10) Pub. No.: US 2011/0213954 A1
(43) Pub. Date: Sep. 1, 2011

(54) METHOD AND APPARATUS FOR GENERATING MINIMUM BOOT IMAGE

(75) Inventors: Kun-hoon BAIK, Seoul (KR); Jin-hee CHOI, Suwon-si (KR); Su-chang WOO, Suwon-si (KR); Sae-na KIM, Suwon-si (KR)

(73) Assignee: Samsung Electronics Co., Ltd., Suwon-si (KR)

(21) Appl. No.: 13/036,865

(22) Filed: Feb. 28, 2011

(30) Foreign Application Priority Data
Feb. 26, 2010 (KR) 10-2010-0018237

(51) Int. Cl. G06F 9/00

(52) U.S. Cl. 713/2

(57) ABSTRACT

A boot image generating method including erasing code used to execute an application that is executing in a device at a predetermined time from a volatile memory of the device; storing data used to execute the application in a non-volatile memory; and generating a boot image including at least one selected from the group consisting of a code used to execute an Operating System (OS) of the device and data used to execute the OS at the predetermined time.

### PRIORITY

This application claims priority under 35 U.S.C. §119(a) to Korean Patent Application No. 10-2010-0018237, filed on Feb. 26, 2010, in the Korean Intellectual Property Office, the entire disclosure of which is incorporated herein by reference.

### BACKGROUND OF THE INVENTION

1. Field of the Invention

The present invention generally relates to a method and apparatus for generating a boot image, and more particularly, to a method and apparatus for generating a boot image including indispensable elements necessary for booting a device.

2. Description of the Related Art

Booting is a bootstrapping process that starts Operating Systems (OSs) when a computer system is turned on and the main OS is loaded for the computer. Booting is a bootstrapping process of controlling computer resources such as a Central Processing Unit (CPU), a memory, etc., by the OSs, making predetermined applications ready to run based on the OSs, and executing various service applications. In general, a bootstrapping process of loading the main OS into the memory, setting peripheral devices such as input/output devices, and executing service applications is extremely time consuming. Such boot time is likely to cause user dissatisfaction.

### SUMMARY OF THE INVENTION

The present invention provides a method and apparatus for generating a boot image for quick booting.

The present invention also provides a method and apparatus for performing booting based on a boot image.

The present invention also provides a computer readable recording medium having embodied thereon a program for executing the method.

According to an aspect of the present invention, a boot image generating method is provided, including erasing code used to execute an application that is executing in a device at a predetermined time from a volatile memory of the device; storing data used to execute the application in a non-volatile memory; and generating a boot image including at least one selected from the group consisting of a code used to execute an OS of the device and data used to execute the OS at the predetermined time.

The code used to execute the application may be code copied from the non-volatile memory to the volatile memory to execute the application, the data used to execute the OS further includes information regarding a location where at least one selected from the group consisting of the code used to execute the application and the data used to execute the application is stored.

The boot image may further include information regarding a status of at least one peripheral device embedded in the device at the predetermined time.

The boot image may further include information regarding a file relating to a process that is being performed at the predetermined time.

The boot image may further include information regarding a screen displayed on the device at the predetermined time.

The boot image may further include information regarding a location where the information regarding the screen is stored.

The boot image generating method may further include storing the boot image stored in the volatile memory in the non-volatile memory.

The predetermined time may be a time of an idle status in which an application does not operate in the device, excluding the OS for operating the device and at least one service application executed to operate the device.

The boot image generating method may further include if content included in the boot image is changed, regenerating the boot image.

According to another aspect of the present invention, a booting method is provided, including loading, to the volatile memory, a boot image generated after erasing code used to execute an application that is executing in a device at a predetermined time from a volatile memory of the device and storing data used to execute the application in a non-volatile memory, and generated to include at least one selected from the group consisting of a code used to execute an OS of the device and data used to execute the OS at the predetermined time; and restoring a status of the device to a status at the predetermined time based on the loaded boot image.

According to another aspect of the present invention, a boot image generating apparatus is provided, including a swapping unit for erasing code used to execute an application that is executing in a device at a predetermined time from a volatile memory of the device, and storing data used to execute the application in a non-volatile memory; and a boot image generating unit for generating a boot image including at least one selected from the group consisting of a code used to execute an OS of the device and data used to execute the OS at the predetermined time.

According to another aspect of the present invention, a booting apparatus is provided, including a loading unit for loading, to the volatile memory, a boot image generated after erasing code used to execute an application that is executing in a device at a predetermined time from a volatile memory of the device and storing data used to execute the application in a non-volatile memory, and generated to include at least one selected from the group consisting of a code used to execute an OS of the device and data used to execute the OS at the predetermined time; and a booting unit for restoring a status of the device to a status at the predetermined time based on the loaded boot image.

According to another aspect of the present invention, a computer readable recording medium is provided, having embodied thereon a program for executing the boot image generating method and the booting method.

### BRIEF DESCRIPTION OF THE DRAWINGS

The above and other features and advantages of the present invention will become more apparent by describing in detail embodiments thereof with reference to the attached drawings in which:

FIG. 1 is a block diagram illustrating a device including a boot image generating apparatus and a booting apparatus according to an embodiment of the present invention;

FIG. 2 is a block diagram illustrating a boot image generating apparatus according to an embodiment of the present invention;

FIGS. 3A and 3B are diagrams illustrating a method of controlling a volatile memory for generating a boot image according to embodiments of the present invention;

FIGS. 4A and 4B are diagrams illustrating a boot image according to embodiments of the present invention;

FIG. 5 is a block diagram illustrating a booting apparatus according to an embodiment of the present invention;

FIG. 6 is a flowchart illustrating a boot image generating method according to an embodiment of the present invention;

FIG. 7 is a flowchart illustrating a boot image generating method according to another embodiment of the present invention;

FIG. 8 is a flowchart illustrating a booting method according to an embodiment of the present invention; and

FIG. 9 is a flowchart illustrating a method of deleting or correcting a file relating to a process that is being performed when a boot image is generated according to an embodiment of the present invention.

### DETAILED DESCRIPTION OF EMBODIMENTS OF THE PRESENT INVENTION

Embodiments of the present invention will be described below in more detail with reference to the accompanying drawings.

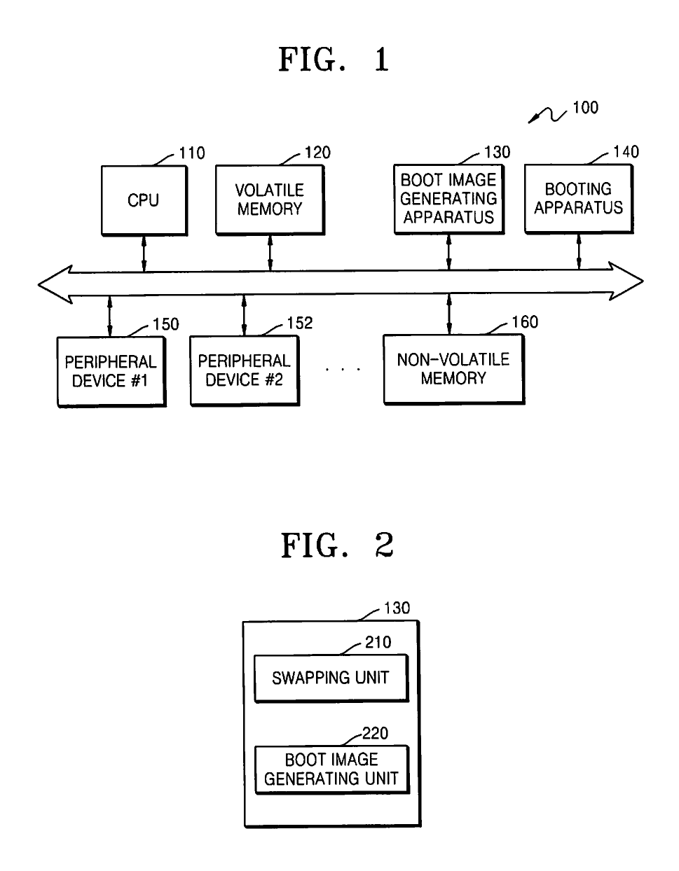

FIG. 1 is a block diagram illustrating a device 100 including a boot image generating apparatus 130 and a booting apparatus 140 according to an embodiment of the present invention.

Referring to FIG. 1, the device 100 includes a CPU 110, a volatile memory 120, the boot image generating apparatus 130, the booting apparatus 140, peripheral devices 150 through 152, and a non-volatile memory 160.

The CPU 110 processes code used to execute an OS and an application by using data stored in the volatile memory 120 and the non-volatile memory 160.

The volatile memory 120 reads and loads the code and data relating to the OS and application that is executing from the non-volatile memory 160, so that the CPU 110 can access the code and data relating to the OS and the application. The volatile memory 120 may be a Random Access Memory (RAM), i.e., a main memory.

The boot image generating apparatus 130 generates a boot image of the device 100. The boot image generating apparatus 130 extracts a plurality of pieces of information regarding a status of the device 100 at a specific time, and generates the boot image based on the extracted information regarding the status of the device 100.

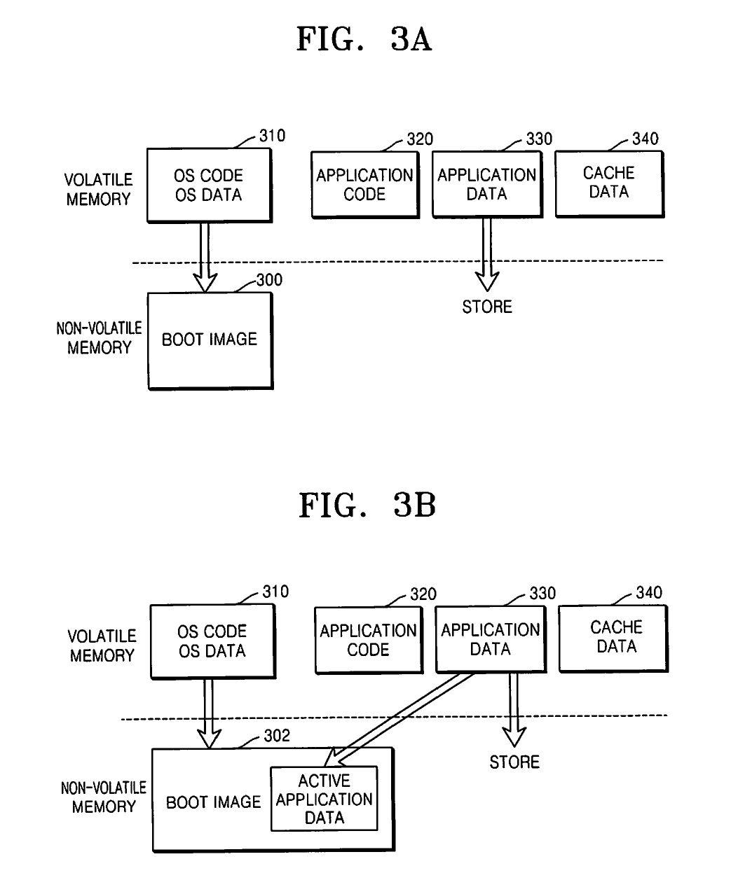

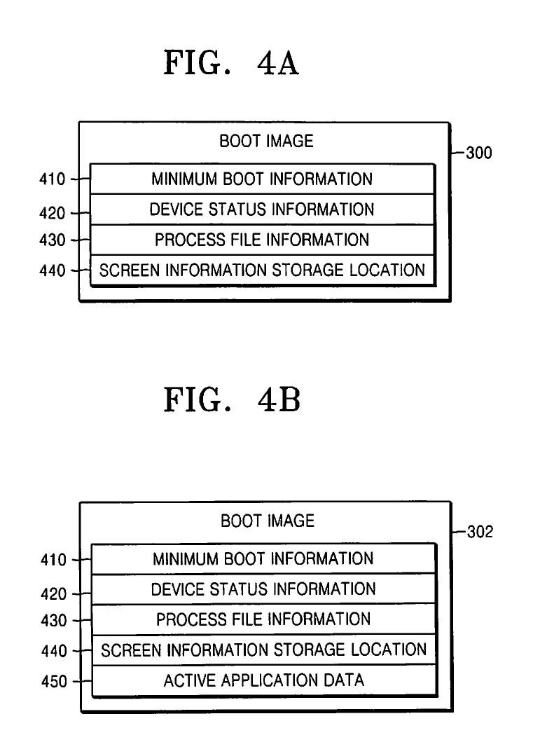

The boot image is made up of data including all types of information necessary for restoring the device 100 to the status at the specific time, and may be generated as a single file. The information regarding the status of the device 100 at the specific time may include the code and the data stored in the volatile memory 120 and information regarding statuses of the peripheral devices 150 through 152. The boot image and a method of generating the boot image according to an embodiment of the present invention will be described in more detail with reference to FIGS. 3 and 4.

The booting apparatus 140 boots the device 100 based on the boot image generated by the boot image generating apparatus 130. The status of the device 100 at the time when the boot image is generated is restored based on the boot image.

The code and data loaded in the volatile memory 120 may be restored when the boot image is generated, and statuses of the peripheral devices 150 through 152 may be restored.

The peripheral devices 150 through 152 are embedded in the device 100 to perform specific functions and may include a graphic module (e.g., a graphic chip) embedded in the device 100, a communication module used to communicate with an external device, etc.

The non-volatile memory 160 is a device for storing the code and data used to execute the OS and the application of the device 100, and may be a memory device, such as a Hard Disk Drive (HDD), a memory card, etc., from which data is not erased when the device 100 is powered off, unlike the volatile memory 120.

FIG. 2 is a block diagram illustrating the boot image generating apparatus 130 according to an embodiment of the present invention.

Referring to FIG. 2, the boot image generating apparatus 130 includes a swapping unit 210 and a boot image generating unit 220. The swapping unit 210 erases code and data stored in the volatile memory 120 at the time when a boot image is generated or stores the code and data in a non-volatile memory.

The volatile memory 120 stores code and data relating to an OS and an application of the device 100. The code are bitstreams analyzed and processed by the CPU 100 to perform the OS or the application. The data is a bitstream referred to by or generated by the OS or the application during the execution of the OS or the application. The data may be loaded from the non-volatile memory 160 to the volatile memory 120 to execute the OS or the application.

The boot image generating apparatus 130 of the present embodiment generates the boot image by extracting indispensable elements necessary for booting, including information relating to the OS, and the swapping unit 210 erases the code and data from the volatile memory 120 excluding the indispensable elements necessary for booting. This will be described in more detail with reference to FIG. 3.

The boot image may be generated at a time of an idle status in which an application does not operate, excluding the OS for operating the device 100 and at least one service application. The service application is an application that indispensably executes so as to operate the device 100 other than the OS. For example, in a smart phone, the service application may include an application for communication, an application for controlling a display device, and the like.

However, it will be understood by those of ordinary skill in the art that the boot image can be generated at the time when the application operates, excluding the OS and the at least one service application.

FIG. 3A is a diagram illustrating a method of controlling the volatile memory 120 for generating a boot image 300 according to an embodiment of the present invention.

Referring to FIG. 3A, information 310 regarding an OS, an application code 320, application data 330, and cache data 340 may be loaded in the volatile memory 120 at the time when the boot image 300 is generated.

The information 310 regarding the OS includes code (OS code) used to execute the OS and data (OS data) used to execute the OS.

The code used to execute the OS may include a code that must be executed to maintain the OS. The data used to execute the OS may include data and a data structure that are derived and referred during the execution of the OS. The data used to execute the OS may be data loaded from the non-volatile memory 160 to execute the OS.

The data used to execute the OS may include information regarding a page table, a page structure used to execute the OS, a task structure allocated to an application, a memory structure, and the like.

When a device is restored based on the boot image 300, the data used to execute the OS may include information regarding a location, where a code used to execute an application and data used to execute the application is stored, in the non-volatile memory. The information regarding the location is used to restore execution statuses of applications.

The application code 320 may be a code used to execute the application. In general, if a predetermined application operates in the device 100, the code used to execute the application is loaded into the volatile memory 120 for a quick access, and the CPU 110 accesses the code loaded in the volatile memory 120. The application code 320 may be code copied from the non-volatile memory 160 to the volatile memory 120 to execute the application.

The application data 330 may be the data used to execute the application. All types of data and data structures that are generated by executing the application and are referred to by an executing application may be the data used to execute the application. Like the data used to execute the OS, the data used to execute the application may be data loaded from the non-volatile memory 160.

The cache data 340 may be data loaded from the non-volatile memory 160 to the volatile memory 120 such that the OS that is executing or application can access the data quickly.

The swapping unit 210 erases the application code 320 and the cache code 340 from among the data stored in the volatile memory 120. The application code 320 is copied from the code used to execute the application stored in the non-volatile memory 160. Thus, although the application code 320 is erased, the erased application code 320 can be loaded from the non-volatile memory 160 when a system is restored.

The cache data 340 is temporally generated data in order to enable a quick access of the OS or the application. If the OS or the application is executed again, since the cache data 340 can be regenerated, the cache data 340 may be erased from the volatile memory 120.

To copy and restore the application code 320 loaded into the volatile memory 120 from the non-volatile memory 160 at a specific time, a location, where the application code 320 is stored, in the non-volatile memory 160 must be known. Therefore, the data used to execute the OS includes information regarding the location, where the application code 320 is stored, in the non-volatile memory 160. When the device 100 is restored, the application code 320 may be loaded from the non-volatile memory 160 again based on the information.

The swapping unit 110 stores the information 310 regarding the OS and the application data 330 from the data loaded in the volatile memory 120 in the non-volatile memory 160. The information 310 regarding the OS that is indispensable to the restoration of the device 100 may be included in the boot image 300, whereas the application data 330 may be stored separately from the boot image 300. The application data 330 may execute the application again after the OS is restored, and may be stored as an auxiliary boot image, separately from the boot image 330.

FIG. 3B is a diagram illustrating a method of controlling the volatile memory 120 for generating the boot image 300 according to another embodiment of the present invention.

Referring to FIG. 3B, a part of the application data 330 may be included in the boot image 302. Since data of the application data 330 that is frequently accessed by an OS or an application must be restored quickly when the device 100 is restored, the frequently accessed data is included in the boot image 302 as active application data.

The OS may determine the data of the application data 300 that is frequently accessed through a predetermined algorithm. For example, the OS may determine recently accessed data of the application data 330 through a Least Recently Used (LRU) algorithm or may determine the frequently accessed data by counting the access number in a predetermined period of time before the boot image 300 is generated.

The swapping unit 110 separates data which is not frequently accessed data, determined by the predetermined algorithm from the application data 330 and stores the separated data in the non-volatile memory 160.

Referring back to FIG. 2, the boot image generating unit 220 generates a boot image for booting the device 100 based on results of erasure and storage of the swapping unit 210. This will be described in detail with reference to FIGS. 4A and 4B.

FIG. 4A is a block diagram illustrating boot image 300 according to an embodiment of the present invention.

Referring to FIG. 4A, the boot image 300 may include minimum boot information 410, device status information 420, process file information 430, and a screen information storage location 440.

The minimum boot information 410 includes the information 310 regarding the OS. The information 310 regarding the OS may include the code used to execute the OS and the data used to execute the OS that are loaded in the volatile memory 120 when the boot image 300 is generated.

The minimum boot information 410 may also include information regarding a screen displayed on the device 100 when the boot image 300 is displayed. Thus, the information regarding the screen displayed on a display unit of the device 100 is included in the minimum boot information 410, thereby restoring the screen viewed by a user quickly when the device 100 is booted by using the boot image 300.

The device status information 420 includes information regarding statuses of the peripheral devices 150 through 152 at the time when the boot image 300 is generated. After the peripheral devices 150 through 152 are stopped, the device status information 420 may be included in the boot image 300 as information regarding stop statuses of the peripheral devices 150 through 152.

The process file information 430 includes information regarding a file relating to a process that is being performed in the device 100 when the boot image 300 is generated. When the device 100 is booted based on the boot image 300, if the file relating to the process that is being performed in the device 100 when the boot image 300 is generated does not exist, a system error may occur.

For example, if a file, A, relates to the process that is being performed in the device 100 when the boot image 300 is generated, and is deleted from the device 100 after the boot image 300 is generated, when the device 100 is booted again based on the boot image 300, the process during the generation of the boot image 300 may not be restored and performed again. Therefore, the information regarding the file relating to the process that is being performed in the device 100 may be stored in the boot image 300, and a user of the device 100 may not delete or correct the file relating to the process. The process file information 430 may be information regarding a location, where the file relating to the process that is being performed is stored, in the non-volatile memory 160.

Information regarding the screen information storage location 440 includes information regarding a location where the information regarding the screen displayed on the device 100 is stored. As described above, to restore the screen displayed when the device 100 is booted quickly, the information regarding the screen of the device 100 is included in the minimum boot information 410 at the time when the boot image 300 is generated. However, when the user changes the screen displayed after the boot image 300 is generated (for example, a background of a computer or a background of a smart phone is changed), if the boot image 300 is not changed, the changed screen may not be displayed on the device 100 when the device 100 is booted again.

Therefore, whenever the user changes the screen, the boot image 300 must be regenerated in order to display the screen changed by the user on the device 100 when the device 100 is booted again. However, the boot image 300 must be repeatedly used in order to continuously restore the device 100 in the same way other than the screen. Thus, the information regarding the screen must be changed in the boot image 300 separately. To this end, the boot image 300 separately includes information regarding a location, where the information regarding the screen of the device 100 is stored, in the boot image 300.

FIG. 4B is a block diagram illustrating the boot image 302 according to another embodiment of the present invention.

Referring to FIG. 4B, the boot image 302 further includes active application data 450. As described with reference to FIG. 3B, the frequently accessed data of the application data 300 is included in the boot image 302. The minimum boot information 410, the device status information 420, the process file information 430, and the screen information storage location 440 are the same as the boot image 300 shown in FIG. 4A.

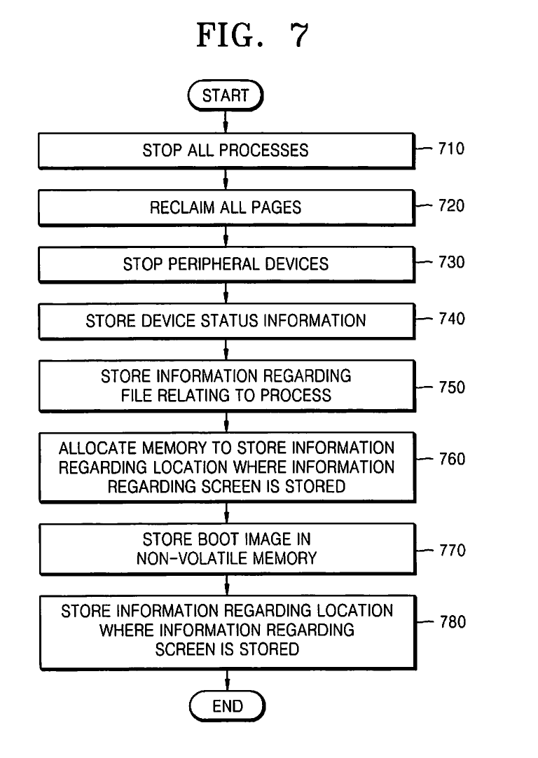

The boot image generating unit 220 of FIG. 2 may generate the boot image 300 or 302 shown in FIG. 4A or 4B in the volatile memory 120 of FIG. 1 and then store the boot image 300 in the non-volatile memory 160 of FIG. 1. To generate the boot image 300 or 302, all processes and peripheral devices must be stopped. Thus, stopped peripheral devices include a device for controlling access to the non-volatile memory 160. Therefore, when the device is stopped, the boot image 300 or 302 is generated in the volatile memory 120, if the boot image 300 or 302 is completely generated, the device resumes operating, and the boot image 300 or 302 is copied in the non-volatile memory 160. This will be described in detail with reference to FIG. 7.

As described in FIGS. 3A, 3B, 4A, and 4B, the boot image generating unit 130 generates the boot image 300 or 302 including only the information 310 regarding the OS by erasing the application code 320 loaded in the volatile memory 120. Thus, a size of the boot image 300 or 302 is reduced, and the status of the device 100 can be restored quickly based on the small size of the boot image 300 or 302. Such a boot image generating method and booting method is referred to as a “full page reclaim”.

To continuously restore the device 100 to the same status, the boot image may be repeatedly used as described above. However, when the boot image 300 or 302 is necessarily regenerated due to a change in content included in the boot image 300 or 302, the boot image generating apparatus 130 regenerates the boot image 300 or 302 by performing the process of generating the boot image described above again.

The change in the screen described above may be reflected in the boot image 300 or 302 by not regenerating the boot image 300 or 302 by using the screen information storage location 440. However, if at least one of a code and data is changed after the boot image 300 or 302 is generated according to an update of an OS or an application, the boot image 300 or 302 must be necessarily regenerated. Therefore, since the boot image generating apparatus 130 cannot reflect the change in content included in the boot image 300 or 302 by correcting the boot image 300 or 302, the boot image 300 or 302 is necessarily regenerated.

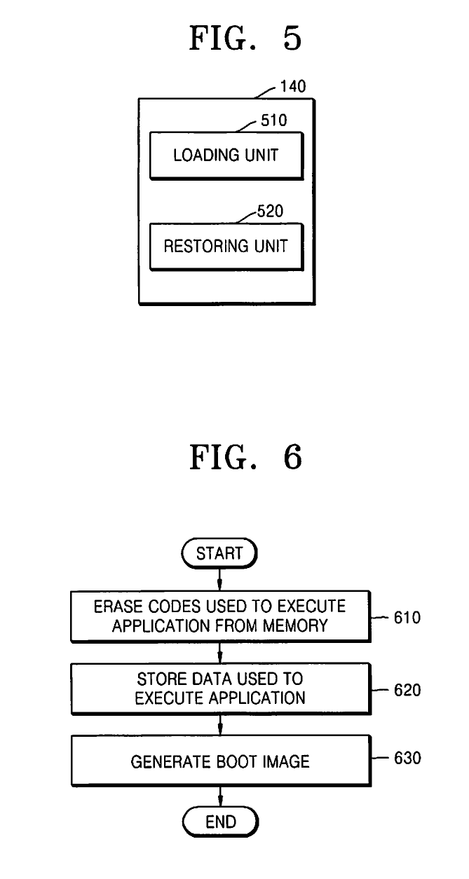

FIG. 5 is a block diagram of the booting apparatus 140 according to an embodiment of the present invention.

Referring to FIG. 5, the booting apparatus 140 includes a loading unit 510 and a restoring unit 520.

The loading unit 510 loads the boot image 300 or 302 generated as shown in FIGS. 3A, 3B, 4A, and 4B in the volatile memory 120 of FIG. 1. The loading unit 510 reads the boot image 300 or 302 stored in the non-volatile memory 160 and loads the boot image 300 in the volatile memory 120.

The restoring unit 520 restores a status of the device 100 based on the boot image 300 or 302 loaded by the loading unit 510. An OS is restored based on the minimum boot information 410 loaded in the volatile memory 120 of the device 100.

If the OS is restored, processes are executed again. One of the processes relating to an application that is executing during the generation of the boot image 300 may cause an error (e.g., a page fault) since the application code 320 is not loaded in the volatile memory 120. Thus, the restoring unit 520 loads the application code 320 in the volatile memory 120 again based on information regarding a location, where the application code 320 is stored, in the non-volatile memory 160, and continues to execute the process. The information regarding the location, where the application code 320 is stored, in the non-volatile memory 160 is included in the information 310 regarding the OS as described above. In the same manner as the application code 320 is restored, the application data 330 may be restored based on information regarding a location, where the application data 330 is stored, in the non-volatile memory 160, if necessary. The application data 330 that is stored in the non-volatile memory 160 as an auxiliary boot image is restored.

When the frequently accessed data of the application data 330 is included in the boot image 302 as the active application data 450, the active application data 450 is restored, and then other application data included in the auxiliary boot image is restored.

A first screen after the device 100 is booted may be displayed based on information regarding a screen of the device 100 included in the minimum boot information 410.

Statuses of the peripheral devices 150 through 152 are restored based on the device status information 420 of the boot image 300 or 302. Registers (e.g., a register located inside or outside the device) of the peripheral devices 150 through 152 are restored based on information regarding statuses thereof stored in the boot image 300.

FIG. 6 is a flowchart illustrating the boot image generating method according to an embodiment of the present invention.

Referring to FIG. 6, in step 610, the boot image generating apparatus 130 erases code used to execute an application operating in the device 100 at the time when the boot image 300 starts generating, i.e. the application code 320, from the volatile memory 120. As described with reference to FIG. 3, the code used to execute the application can be copied from the non-volatile memory 160, and the code is not required to generate the boot image 300. Thus, the boot image generating apparatus 130 erases the code from the volatile memory 120. It is described that the cache data 340, together with the application code 320, may be erased from the volatile memory 120.

In step 620, the boot image generating apparatus 130 stores data used to execute the applications operating in the device 100 at the time when the boot image 300 is generated, i.e. the application data 330, in the non-volatile memory 160. The application data 330 is not completely included in the boot image 300 and may be stored in the non-volatile memory 160 as an auxiliary boot image. Moreover, frequently accessed data of the application data 330 may be included in the boot image 302, and data of the application data 330 which is not frequently accessed may be stored in the non-volatile memory 160 as an auxiliary boot image.

In step 630, the boot image generating apparatus 130 generates the boot image 300 or 302 based on the information 310 regarding an OS of the device 100 that remains in the volatile memory 120 after steps 610 and 620 are performed. As described with reference to FIG. 4, the boot image 300 or 302 may include information other than the information 310 regarding the OS.

If at least one of a code and data is changed after the boot image 300 or 302 is generated according to an update of the OS or the application, since the boot image 300 or 302 is necessarily regenerated, the boot image generating apparatus 130 regenerates the boot image 300 or 302 by performing steps 610 through 630 again.

FIG. 7 is a flowchart illustrating a boot image generating method according to another embodiment of the present invention.

Referring to FIG. 7, in step 710, the boot image generating apparatus 130 allows all processes to stop being performed at a specific time.

In step 720, the boot image generating apparatus 130 reclaims all pages. As described with reference to FIG. 3, the boot image generating apparatus 130 erases code used to execute applications operating in the device 100 of FIG. 1 at the time when the boot image 300 is generated, i.e. the application code 320, and the cache data 340 from the volatile memory 120 of FIG. 1. The application data 330 is stored in the non-volatile memory 160. Then, the boot image 300 or 302 including the information 310 regarding an OS is generated in the volatile memory 120. The boot image 300 or 302 including the minimum boot information 410 including the information 310 regarding the OS and information regarding a screen of the device 100 may be generated. It was described above that frequently accessed data of the application data 330 may be included in the boot image 302.

In step 730, if all peripheral devices are stopped, since an input/output control device for controlling access to the non-volatile memory 160 stops operating, the non-volatile memory 160 cannot be accessed. Thus, if the boot image 300 or 302 is generated first in the volatile memory 120, and then all types of information shown in FIG. 4A or 4B is stored in the boot image 300 or 302, the boot image 300 or 302 is stored in the non-volatile memory 160 in step 770.

In step 730, the boot image generating apparatus 130 stops operating the peripheral devices 150 through 152 embedded in the device 100.

In step 740, the boot image generating apparatus 130 stores the device status information 420 regarding the stop statuses of the peripheral devices 150 through 152 in the boot image 300 or 302. The boot image generating apparatus 130 stores data stored in registers of the stopped peripheral devices 150 through 152 in the boot image 300 or 302 as the information regarding the statuses of the peripheral devices 150 and 152.

In step 750, the boot image generating apparatus 130 stores information regarding a file relating to a process that is being performed. As described with reference to FIG. 4A or 4B, if the file relating to the process that is being performed when the boot image 300 is generated is deleted from the device 100 after the boot image 300 or 302 is generated, since the process cannot be restored after the device 100 is booted according to the boot image 300 or 302, a system error may occur.

Thus, in step 750, the boot image generating apparatus 130 stores information regarding a file relating to the process stopped in step 710, i.e., the process that is being performed when the boot image 300 or 302 is generated, in the boot image 300 or 302. As described above, the information regarding the file relating to the process that is being performed may be information regarding a location, where the file is stored, in the non-volatile memory.

In step 760, the boot image generating apparatus 130 allocates regions in the boot image 300 or 302 for storing information regarding a location where information regarding a screen displayed on the device 100 is stored. The minimum boot image 410 stored in the boot image 300 or 302 includes the information 310 regarding the OS and the information regarding the screen displayed on the device 100 after the device 100 is booted. As shown in FIGS. 4A and 4B, the boot image 300 or 302 includes the screen information storage location 440 as the information regarding a location where information regarding a screen displayed on the device 100 is stored, and thus, in step 760, the boot image generating apparatus 130 allocates a region for storing the screen information storage location 440 in the boot image 300 or 302.

In step 770, the boot image generating apparatus 130 stores the boot image 300 or 302 generated in steps 710 to 760 in the non-volatile memory 160. The boot image generating apparatus 130 operates the peripheral devices for controlling access to the non-volatile memory 160 in order to again store the boot image 300 or 302 stored in the volatile memory 120 in the non-volatile memory 160.

In step 780, the boot image generating apparatus 130 determines a location, where the information regarding the screen is stored, in the non-volatile memory 160, and stores information regarding the location in the boot image 300 or 302. Since the boot image 300 is moved to the non-volatile memory 160 in step 770, the location in which the information regarding the screen is stored, in the non-volatile memory 160 may also be known. The information regarding the location is thus stored as the screen information storage location 440 of the boot image 300 or 302.

If a user changes the screen displayed when the device 100 is booted after the boot image 300 or 302 is generated, the information regarding the screen may be changed based on the information regarding the location where the information regarding the screen is stored. Thus, the boot image 300 or 302 cannot necessarily be generated again, and the information regarding the screen included in the minimum boot information 410 is changed.

However, if at least one of a code and data is changed after the boot image 300 or 302 is generated according to an update of the OS or the application, since the boot image 300 or 302 is necessarily regenerated, the boot image 300 or 302 is regenerated and stored by performing steps 710 through 780 again.

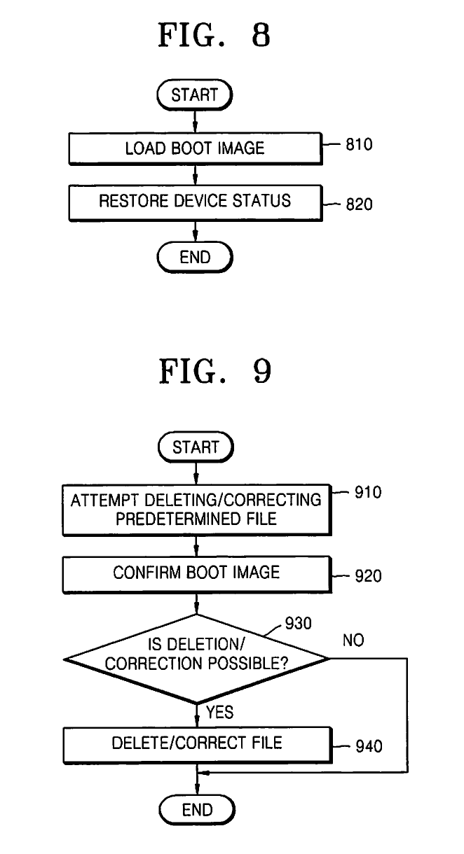

FIG. 8 is a flowchart illustrating a booting method according to an embodiment of the present invention.

Referring to FIG. 8, in step 810, the booting apparatus 140 loads the boot image 300 or 302 stored in the non-volatile memory 160 of FIG. 1 into the volatile memory 120 of FIG. 1. Hardware of the device 100 is initialized to a minimum status accessible to the non-volatile memory 120. It is determined whether the boot image 300 or 302 is stored in the non-volatile memory 160. If the boot image 300 or 302 is not stored in the non-volatile memory 160, general booting which does not use the boot image 300 or 302 is performed. Meanwhile, if the boot image 300 or 302 is stored in the non-volatile memory 160, the boot image 300 or 302 is read from the non-volatile memory 160 by using the loading unit 510 and is loaded to the volatile memory 120.

In step 820, the booting apparatus 140 restores a status of the device 100 based on the boot image 300 or 302 loaded in step 810.

An OS is restored based on the minimum boot information 410 loaded in the volatile memory 120 of the device 100 of FIG. 1.

If the OS is completely restored, statuses of the peripheral devices 150 through 152 are restored based on the device status information 420 of the boot image 300 or 302. Registers of the peripheral devices 150 and 152 of FIG. 1 are restored based on information regarding statues thereof stored in the boot image 300. A process that was stopped when the boot image 300 is generated is resumed again. In this regard, the application data 330 separately stored in the non-volatile memory 160 is loaded to the volatile memory 120 if necessary. Frequently accessed data of the application data 330 may be included in the boot image 302.

FIG. 9 is a flowchart illustrating a method of deleting or correcting a file relating to a process that is being performed when the boot image 300 is generated according to an embodiment of the present invention.

Referring to FIG. 9, in step 910, a user of the device 100 attempts to delete or correct a predetermined file after booting the device 100 according to the boot image 300 or 302 of FIGS. 3A and 3B.

In step 920, the device 100 of FIG. 1 confirms the process file information 430 of the boot image 300 or 302 loaded in the volatile memory 120.

In step 930, it is determined whether the predetermined file to be deleted or corrected in step 910 is the file relating to the process that is being performed when the boot image 300 or 302 is generated. If the predetermined file is the file relating to the process that is being performed when the boot image 300 or 302 is generated, when the predetermined file is deleted or corrected, since the process cannot be executed after the device 100 is booted according to the boot image 300 or 302, a system error occurs. Thus, the predetermined file is prohibited from being deleted or corrected.

If the predetermined file is not the file relating to the process that is being performed when the boot image 300 or 302 is generated, in step 940, the predetermined file is deleted or corrected.

FIG. 9 illustrates the method of selectively deleting or correcting the file when no problem occurs in executing the OS and/or the application although the file is not deleted or corrected. However, as described above, if the file is not deleted or corrected when the OS or the application is updated, such an update is not completed. Therefore, since the file is necessarily deleted or corrected, the boot image 300 or 302 is regenerated after deleting or correcting the file.

According to the embodiments of the present invention, a boot image having a small size including indispensable elements necessary for booting can be generated, and booting can be performed without an error quickly by using the boot image.

Additionally, other embodiments of the present invention can also be implemented through computer readable code/instructions in/on a medium, e.g., a computer readable medium, to control at least one processing element to implement any above described embodiment. The medium can correspond to any medium/media permitting the storage and/or transmission of the computer readable code.

For example, the boot image generating apparatus and the booting apparatus of the present invention may include a bus coupled to each unit of the devices shown in FIGS. 1, 2, and 5, and at least one processor coupled to the bus. To store instructions, receive messages, or generate messages, the boot image generating apparatus and the booting apparatus of the present invention may further include a memory coupled to the at least one processor to execute the instructions.

The computer readable code can be recorded/transferred on a medium in a variety of ways, with examples of the medium including recording media, such as magnetic storage media (e.g., Read Only Memory (ROM), floppy disks, hard disks, etc.) and optical recording media (e.g., CD-ROMs, or DVDs), and transmission media such as Internet transmission media. The medium may be such a defined and measurable structure including or carrying a signal or information, such as a device carrying a bitstream according to one or more embodiments of the present invention. The media may also be a distributed network, so that the computer readable code is stored/transferred and executed in a distributed fashion.

While this invention has been particularly shown and described with reference to embodiments thereof, it will be understood by those of ordinary skill in the art that various changes in form and details may be made therein without departing from the spirit and scope of the invention as defined by the appended claims and equivalents thereof. The embodiments should be considered in a descriptive sense only and not for purposes of limiting the invention. Therefore, the scope of the invention is defined not by the detailed description of the invention but by the appended claims, and all differences within the scope will be construed as being included in the present invention.

What is claimed is:

1. A boot image generating method, the method comprising:
erasing code used to execute an application, that is executing in a device at a predetermined time, from a volatile memory of the device;
storing data used to execute the application in a non-volatile memory; and
generating a boot image including at least one selected from the group consisting of a code used to execute an Operating System (OS) of the device and data used to execute the OS at the predetermined time.

2. The method of claim 1, wherein the code used to execute the application are code copied from the non-volatile memory to the volatile memory to execute the application, and
the data used to execute the OS further comprises information regarding a location where at least one selected from the group consisting of the code used to execute the application and the data used to execute the application is stored.

3. The method of claim 2, wherein the boot image further comprises:
information regarding a status of at least one peripheral device embedded in the device at the predetermined time.

4. The method of claim 3, wherein generating the boot image comprises:
storing the boot image including at least one selected from the group consisting of the code used to execute the OS of the device and data used to execute the OS at the predetermined time in the volatile memory;
stopping operating the at least one peripheral device; and
storing information regarding the status of the stopped at least one peripheral device in the boot image.

5. The method of claim 3, wherein the boot image further comprises:
information regarding a file relating to a process that is being performed at the predetermined time.

6. The method of claim 5, wherein information regarding the file relating to the process comprises:
information regarding a location where the file relating to the process is stored.

7. The method of claim 5, wherein generating the boot image comprises:
storing the boot image including at least one selected from the group consisting of the code used to execute the OS of the device and data used to execute the OS at the predetermined time in the volatile memory;
stopping operating the at least one peripheral device;
storing information regarding the status of the stopped at least one peripheral device in the boot image; and
storing the information regarding the file relating to the process that is being performed in the boot image.

8. The method of claim 5, wherein the boot image further comprises:
information regarding a screen displayed on the device at the predetermined time.

9. The method of claim 8, wherein the boot image further comprises:
information regarding a location where the information regarding the screen is stored.

10. The method of claim 7, further comprising:
storing the boot image stored in the volatile memory in the non-volatile memory.

11. The method of claim 1, wherein the predetermined time is a time of an idle status in which an application does not operate in the device, excluding the OS for operating the device and at least one service application executed to operate the device.

12. The method of claim 1, wherein storing the data used to execute the application in the non-volatile memory comprises:
storing only data used to execute the application in the non-volatile memory, which is not frequently accessed,
wherein the boot image comprises the frequently accessed data.

13. The method of claim 1, further comprising:
if content included in the boot image is changed, regenerating the boot image.

14. A booting method, comprising:
loading, to the volatile memory, a boot image generated after erasing code used to execute an application that is executing in a device at a predetermined time from a volatile memory of the device and storing data used to execute the application in a non-volatile memory, and generated to include at least one selected from the group consisting of a code used to execute an Operating system (OS) of the device and data used to execute the OS at the predetermined time; and
restoring a status of the device to a status at the predetermined time based on the loaded boot image.

15. The method of claim 13, wherein the code used to execute the application are code copied from the non-volatile memory to the volatile memory to execute the application, and
the data used to execute the OS further comprises information regarding a location where at least one selected from the group consisting of the code used to execute the application and the data used to execute the application is stored.

16. The method of claim 15, wherein the boot image further comprises:
information regarding a status of at least one peripheral device embedded in the device at the predetermined time,
wherein the restoring of the status of the device comprises: restoring a status of the at least one peripheral device based on information regarding the status of the at least one peripheral device.

17. A boot image generating apparatus, the apparatus comprising:
a swapping unit for erasing code used to execute an application that is executing in a device at a predetermined time from a volatile memory of the device, and storing data used to execute the application in a non-volatile memory; and
a boot image generating unit for generating a boot image including at least one selected from the group consisting of a code used to execute an Operating System (OS) of the device and data used to execute the OS at the predetermined time.

18. The apparatus of claim 17, wherein the code used to execute the application are code copied from the non-volatile memory to the volatile memory to execute the application, and
the data used to execute the OS further comprises information regarding a location where at least one selected from the group consisting of the code used to execute the application and the data used to execute the application is stored.

19. The apparatus of claim 18, wherein the boot image further comprises:
information regarding a status of at least one peripheral device embedded in the device at the predetermined time.

20. The apparatus of claim 19, wherein the boot image further comprises:
information regarding a file relating to a process that is being performed at the predetermined time.

21. The apparatus of claim 20, wherein the information regarding the file relating to the process comprises:
information regarding a location where the file relating to the process is stored.

22. The apparatus of claim 20, wherein the boot image further comprises:
information regarding a screen displayed on the device at the predetermined time.

23. The apparatus of claim 22, wherein the boot image further comprises:
information regarding a location where the information regarding the screen is stored.

24. The apparatus of claim 17, wherein the swapping unit stores only data of the data used to execute the application in the non-volatile memory, which is not frequently accessed,
wherein the boot image comprises the frequently accessed data.

25. The apparatus of claim 17, further comprising:
boot image generating unit for, if content included in the boot image is changed, regenerating the boot image.

26. A booting apparatus, the apparatus comprising:
a loading unit for loading, to the volatile memory, a boot image generated after erasing code used to execute an application that is executing in a device at a predetermined time from a volatile memory of the device and storing data used to execute the application in a non-volatile memory, and generated to include at least one selected from the group consisting of a code used to execute an Operating System (OS) of the device and data used to execute the OS at the predetermined time; and
a booting unit for restoring a status of the device to a status at the predetermined time based on the loaded boot image.

27. The apparatus of claim 26, wherein the code used to execute the application are code copied from the non-volatile memory to the volatile memory to execute the application,
the data used to execute the OS further comprises information regarding a location where at least one selected from the group consisting of the code used to execute the application and the data used to execute the application is stored.

28. The apparatus of claim 26, wherein the boot image further comprises:
information regarding a status of at least one peripheral device embedded in the device at the predetermined time,
wherein the booting unit restores a status of the at least one peripheral device based on information regarding the status of the at least one peripheral device.

29. The method of claim 1, wherein the erasing further comprises:
erasing cache data of the application and the OS from the volatile memory.

30. The method of claim 9, further comprising:
receiving a change request of the screen displayed on the device at the predetermined time; and
changing the information regarding the screen displayed on the device of the boot image based on the information regarding the location where the boot image where the information regarding the screen is stored.

31. A file changing method, the method comprising:
erasing code used to execute an application that is executing in a device at a predetermined time from a volatile memory of the device, storing data used to execute the application in a non-volatile memory, loading, to the volatile memory, a boot image generated to include at least one selected from the group consisting of a code used to execute an Operating System (OS) of the device and data used to execute the OS at the predetermined time, and restoring a status of the device to a status at the predetermined time based on the loaded boot image;
receiving a request to delete or correct a predetermined file; and
selectively deleting or correcting the predetermined file of the boot image based on information regarding a file relating to a process that is being performed at the predetermined time.

32. A computer readable recording medium having embodied thereon a program for executing a method, the method comprising:
erasing code used to execute an application, that is executing in a device at a predetermined time in a volatile memory of the device;
storing data used to execute the application in a non-volatile memory; and
generating a boot image including at least one selected from the group consisting of a code used to execute an Operating System (OS) of the device and data used to execute the OS at the predetermined time.

33. A computer readable recording medium having embodied thereon a program for executing a method, the method comprising:
loading, to the volatile memory, a boot image generated after erasing code used to execute an application that is executing in a device at a predetermined time from a volatile memory of the device and storing data used to execute the application in a non-volatile memory, and generated to include at least one selected from the group consisting of a code used to execute an Operating system (OS) of the device and data used to execute the OS at the predetermined time; and
restoring a status of the device to a status at the predetermined time based on the loaded boot image.

34. A computer readable recording medium having embodied thereon a program for executing a method, the method comprising:
erasing code used to execute an application that is executing in a device at a predetermined time from a volatile memory of the device, storing data used to execute the application in a non-volatile memory, loading, to the volatile memory, a boot image generated to include at least one selected from the group consisting of a code used to execute an Operating System (OS) of the device and data used to execute the OS at the predetermined time, and restoring a status of the device to a status at the predetermined time based on the loaded boot image;
receiving a request to delete or correct a predetermined file; and
selectively deleting or correcting the predetermined file of the boot image based on information regarding a file relating to a process that is being performed at the predetermined time.
